(19) United States
(12) Patent Application Publication
(10) Pub. No.: US 2013/0313990 A1
(43) Pub. Date: Nov. 28, 2013

(54) DISPLAY AND LIGHT SOURCE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,123

(22) Filed: Dec. 23, 2012

(30) Foreign Application Priority Data
May 24, 2012 (CN) 201210163775.1

(51) Int. Cl. H05B 37/02

(52) U.S. Cl. CPC H05B 37/02
USPC 315/201; 315/291

(57) ABSTRACT

A device includes a light emitting diode (LED) module and a switch. The switch further includes a first contact grounded through a first resistor, a second contact grounded through a second resistor, and a fixed contact connecting to the LED module. When the fixed contact is connected to the first contact and the first resistor, the device is operated as a display device and the LED module is operated as a backlight source for the display device. When the fixed contact is connected to the second contact and the second resistor, the LED module is operated as a light source.

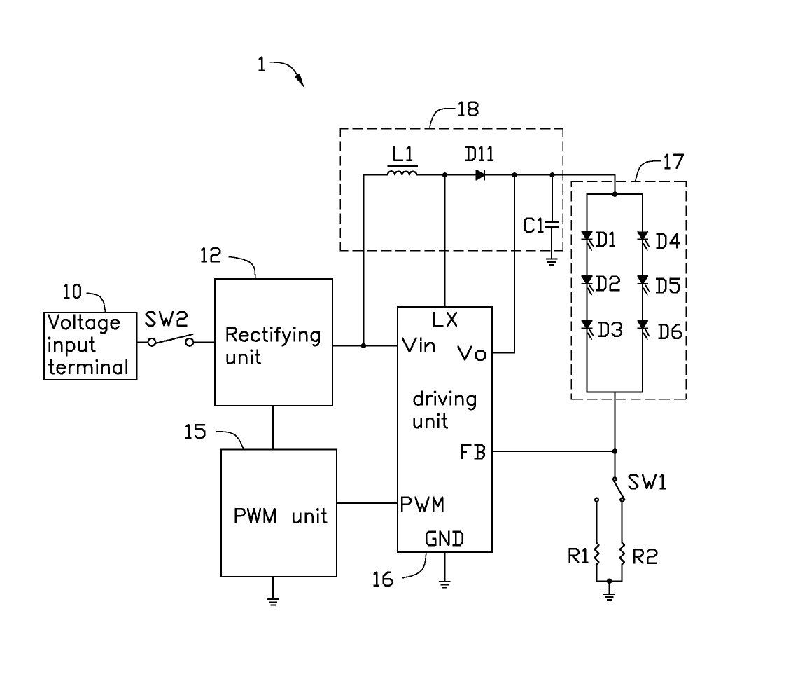

### BACKGROUND

1. Technical Field

The present disclosure relates to a device used as a display device or a light source, and particularly to a display device capable of being a lamp or a lamp capable of being a display.

2. Description of Related Art

A display is essential for a computer. A user generally puts the display device on a table. However, this reduces the real estate on the table for other objects, such as a table lamp.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of a device of the present disclosure.

### DETAILED DESCRIPTION

The FIGURE shows a circuit of a device 1 of the embodiment. The device 1 is used for displaying and lighting. The device 1 includes a voltage input terminal 10, a rectifying unit 12, a pulse-width modulation (PWM) unit 15, a driving unit 16, a light source 17, a bootstrap circuit 18, a first and a second resistors R1-R2, and a first and a second switch SW1-SW2. In the embodiment, the device 1 is a display device or a lighting device. In the embodiment, the display device is a display having a backlight source.

In the embodiment, the voltage input terminal 10 is a plug receiving an alternating current (AC) voltage. The rectifying unit 12 rectifies the AC voltage to a direct current (DC) voltage. The PWM unit 15 is a PWM generator providing a PWM signal. The driving unit 16 is a driving chip. The light source 17 is a light emitting diode (LED) module 17. The LED module 17 includes a plurality of LED units, such as six LED units D1-D6 in this embodiment. The bootstrap circuit 18 includes a diode D11, an inductor L1 and a capacitor C1. The first switch SW1 includes a fixed contact, a first contact, and a second contact. In the embodiment, each of the LED module 17, the LED units D1-D6, and the diode D11 includes an anode and a cathode. In addition, the first resistor R1 has a first resistance value, and the second resistor R2 has a second resistance value smaller than the first resistance value.

The voltage input terminal 10 is connected to the rectifying unit 12 through the second switch SW2. The rectifying unit 12 is connected to the PWM unit 15 and the driving unit 16. The PWM unit 15 is connected to the driving unit 16 providing the PWM signal to the driving unit 16. The driving unit 16 is connected to the LED module 17 providing an operating voltage of the LED module 17.

The driving unit 16 includes an input pin Vin, an output pin Vo, a control pin LX, a PWM pin PWM, a feedback pin FB, and a ground pin GND. The input pin Vin of the driving unit 16 is connected to the rectifying unit 12 and to the anode of the diode D11 through the inductor L1. The anode of the diode D11 is connected to the control pin LX of the driving unit 16. The cathode of the diode D11 is connected to the output pin Vo of the driving unit 16 and grounded through the capacitor C1. The PWM pin PWN of the driving unit 16 is connected to the PWM unit 15. The output pin Vo of the driving unit 16 is connected to the anode of the LED module 17, i.e. the anodes of the first and the fourth LED units D1 and D4. The cathode of the first LED unit D1 is connected to the anode of the second LED unit D2. The cathode of the second LED unit D2 is connected to the anode of the third LED unit D3. The cathode of the fourth LED unit D4 is connected to the anode of the fifth LED unit D5. The cathode of the fifth LED unit D5 is connected to the anode of the sixth LED unit D6. The feedback pin FB of the driving unit 16 is connected to the cathode of the LED module 17, i.e. the cathodes of the third and the sixth LED units D3 and D6. The feedback pin FB is further connected to the fixed contact of the first switch SW1. The first contact of the first switch SW1 is grounded through the first resistor R1. The second contact of the first switch SW1 is ground through the second resistor R2.

The first switch SW1 changes the LED module 17 to be a backlight source for the display device or a light source for the lighting device. Thus, the first resistance value and the second resistance value may be controlled to adjust the current flowing through the LED module 17. If the LED module 17 is operated as the backlight source for the display device, the fixed contact is connected to the first contact so that the LED module 17 is grounded through the first resistor R1. Thus, a first current flowing through the LED module 17 and a first luminous intensity of the emitted light of the LED module 17 are determined by the first resistance value of the first resistor R1. Therefore, the first resistance value is selected in advance for controlling the LED module 17 to operate as the backlight source. If the LED module 17 is operated as the light source for the lighting device, the fixed contact is connected to the second contact so that the LED module 17 is grounded through the second resistor R2. Thus, a second current flowing through the LED module 17 and a second luminous intensity of the emitted light of the LED module 17 are determined by the second resistance value of the second resistor R2. Therefore, the second resistance value is selected in advance for controlling the LED module 17 to operate as the light source of the lighting device.

Since the luminous intensity of lighting devices are generally larger than that of display devices, the second current is larger than the first current. Thus, the second resistance value is smaller than the first resistance value. In another embodiment, the second resistance R2 is an adjustable resistance so that the second luminous intensity of the LED module 17 can be adjusted by changing the second resistance value of the second resistance R2 when the device 1 is operated as a lighting device.

An operating principle of the embodiment of the present disclosure is described as follows.

The voltage input terminal 10 is plugged into the mains power source to receive the AC voltage, and the AC voltage is rectified to the DC voltage by the rectifying unit 12. The DC voltage is provided to the PWM unit 15 and the driving unit 16. The bootstrap circuit 18 is connected to the driving unit 16 to increase an output voltage of the driving unit 16.

The PWM unit 15 adjusts an operating period of the PWM signal and provides the PWM signal to the driving unit 16 for changing the output voltage of the driving unit 16. Thus, luminous intensity of the LED units D1-D6 can be adjusted by the PWM unit 15. Similar methods for adjusting the luminous intensity of the LED units on a display device are well-known in related art so that the related methods are not further described in this disclosure.

During operation, the second switch SW2 is closed so that the rectifying unit 12 rectifies the AC voltage to provide the DC voltage to the PWM unit 15 and the driving unit 16. When a computing device, such as a personal computer (PC), connected to the device 1 is being operated, the device 1 is utilized as a display device showing a screen. Thus, the first switch SW1 is switched to connect the fixed contact to the first contact so the cathode of the LED module 17 is grounded through the first resistor R1. Therefore, the LED module 17 is controlled to emit light with the first luminous intensity, and the first luminous intensity of the LED module 17 is similar in intensity to a backlight source of a conventional display device.

When the computing device is powered off, it is unnecessary for the device 1 to be a display device. At this time, a user may need a lighting device, such as desk lamp, to illuminate an operating area of the user, such as a top of a table. Thus, the first switch SW1 can be switched to connect the fixed contact to the second contact, so the cathode of the LED module 17 is grounded through the second resistor R2. Therefore, the LED module 17 is controlled to emit light with the second luminous intensity, and the second luminous intensity of the LED module 17 is similar in intensity to a light source of a conventional lighting device.

The above device 1 for displaying and lighting can use the LED module 17 to be a light source. In addition, the first switch SW1, the first resistor R1, and the second resistor R2 operate the LED module 17 as a backlight source of a display device by adjusting the current flowing through the LED module 17. Thus, the device 1 can be a display device and a lighting device so that an available space of a table surface can be saved.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A display device, comprising:
a voltage input terminal;
a first switch comprising a first contact grounded through a first resistor with a first resistance value, a second contact grounded through a second resistor with a second resistance value, and a fixed contact; and
a light emitting diode (LED) module connecting to the fixed contact and receiving an operating voltage through the voltage input terminal, wherein the LED module emits light with a first luminous intensity when being used as a computer display by a first current flowing according to the first resistance value when the fixed contact is connected to the first contact, and the LED module emits light with a second luminous intensity when being used as a lighting device by a second current flowing according to the second resistance value when the fixed contact is connected to the second contact.

2. The display device of claim 1, comprising:
a rectifying unit configured to rectify an alternating current (AC) voltage received from the voltage input terminal to a direct current (DC) voltage; and
a driving unit receiving the DC voltage from the rectifying unit and providing an output voltage according to a pulse-width modulation (PWM) signal from a PWM generating unit.

3. The display device of claim 2, wherein the LED module comprises first, second, third, and fourth LED units, and each of the LED units comprises an anode and a cathode, wherein the driving unit is connected to the anodes of the first and the third LED units, the cathode of the first LED unit is connected to the anode of the second LED unit, the cathode of the third LED unit is connected to the anode of the fourth LED unit, the fixed contact is connected to the cathodes of the second and the fourth LED units.

4. The display device of claim 2, comprising:
a second switch configured to switch a connection between the voltage input terminal and the rectifying unit.

5. The display device of claim 2, comprising:
a bootstrap circuit connecting to the driving unit and configured to increase the output voltage of the driving unit and to provide the operating voltage to the LED modules.

6. The display device of claim 5, wherein the bootstrap circuit comprises an inductor, a diode and a capacitor, the inductor is connected to an input pin of the driving unit and an anode of the diode, the anode of the diode is connected to a control pin of the driving unit, a cathode of the diode is connected to an output pin of the driving unit and grounded through the capacitor, and the output pin of the driving unit is connected to the anode of the LED module.

7. The display device of claim 1, wherein the first current is less than the second current and the first luminous intensity is less than the second luminous intensity when the first resistance value is larger than the second resistance value.

8. The display device of claim 1, wherein the LED module is a backlight source for the computer display, and the emitted light with the first luminous intensity is a backlight for displaying a screen.

9. The display device of claim 1, wherein the LED module is a light source for the lighting device, and the LED module illuminates an area through the emitted light with the second luminous intensity.

10. A display device, comprising:
a voltage input terminal;
a light source receiving an operating voltage through the voltage input terminal; and
a switch comprising a first contact, a second contact and a fixed contact, wherein the fixed contact is connected to the light source, the light source emits light with a first luminous intensity when being used as a computer display when the fixed contact is connected to the first contact, and the light source emits light with a second luminous intensity when being used as a lighting device when the fixed contact is connected to the second contact.

11. The display device of claim 10, wherein the first contact is grounded through a first resistor with a first resistance value, and the second contact is grounded through a second resistor with a second resistance value smaller than the first resistance value.

12. The display device of claim 10, wherein the second luminous intensity is larger than the first luminous intensity.

13. The display device of claim 10, wherein the light source illuminates an area when the fixed contact is connected to the second contact.
